(19) United States
(12) Patent Application Publication
(10) Pub. No.: US 2021/0031440 A1
(43) Pub. Date: Feb. 4, 2021

(54) METHOD AND ASSEMBLY FOR A CONTINUOUS OR SEMI-CONTINUOUS ADDITIVE MANUFACTURE OF COMPONENTS

(71) Applicant: FRAUNHOFER-GESELLSCHAFT ZUR FOERDERUNG DER ANGEWANDTEN FORSCHUNG E.V., Muenchen (DE)

(72) Inventors: HOLGER LEONARDS, Köln (DE); ANDREAS HOFFMANN, Aachen (DE); ARNOLD GILLNER, Roetgen (DE); OLIVER NOTTRODT, Aachen (DE)

(21) Appl. No.: 17/043,760

(22) PCT Filed: Apr. 5, 2018
(86) PCT No.: PCT/EP2018/058705

§ 371 Date: Sep. 30, 2020

(51) Int. Cl. B29C 64/124; B29C 64/393; B33Y 10/00; B33Y 30/00; B33Y 70/00

(52) U.S. Cl. CPC B29C 64/124; B29C 64/393; B29K 2033/12; B33Y 30/00; B33Y 70/00; B33Y 10/00

(57) ABSTRACT

In a photochemical method for the additive manufacture of components a construction material is used which can undergo a further phase transition controllable by cooling between the liquid phase and a solid aggregate state as a second solid phase during the additive manufacture, which does not influence the first solid phase produced by radiation for the construction of the components. The further phase transition is controlled during the construction of the components so that component regions solidified whilst forming the first solid phase are supported by surrounding construction material in the second solid phase. A block of solidified construction material formed by the transition into the second solid phase is conveyed by an advancing device laterally approaching and engaging the block contrary to the construction direction in order to construct the components. This enables a continuous fabrication of the components without interruptions due to a change of the construction platform.

### TECHNICAL AREA OF APPLICATION

The present invention relates to a method and an assembly for the additive manufacture of components in which the components are constructed by layer-by-layer solidification of a construction material that can be transferred from a liquid into a first solid phase by chemical reaction, wherein the layer-by-layer solidification takes place with the formation of the first solid phase in each case by positionally selective irradiation of a layer of the liquid phase of the construction material according to the component geometry.

The generative manufacture of components, also designated as additive manufacture, now plays an important role in many technical areas, since functional components can be produced using this method. In generative manufacture, starting from a CAD model (CAD: computer-aided design), the component is divided digitally into layers and constructed layer by layer in the subsequent manufacturing process. Various techniques are known for this construction which can be divided into physical and chemical or photochemical methods.

At the present time, additive manufacture is only used for small batch sizes of about 1 to 1000 items/year and individual products, models or prototypes. Additive manufacturing methods cannot compete with technologies for very large numbers of items (>>1000) such as, for example, injection moulding. However between batch size 1 and mass production, there is a range of batch production (the same material but varying geometry) which is not appropriately covered by additive manufacturing methods nor by moulding tool methods such as, for example, injection moulding. The hitherto known additive manufacturing methods are too slow and too expensive for this application. Tools for shaping methods are also very expensive for small numbers of items.

### PRIOR ART

Some known additive methods use the physical processes of melting and solidification to produce three-dimensional components. Examples are, in particular, FDM (Fused Deposition Modelling) and SLM/SLS (Selective Laser Melting/Sintering). In FDM thermoplastic materials are conveyed in the form of a filament into a nozzle device, melted by supplying thermal energy and then selectively deposited as molten thread. As a result of cooling, the thermoplastic material then obtains its strength again and the three-dimensional component is constructed. In SLM/SLS thermoplastic materials or also other materials are selectively melted with a laser beam. The starting material is applied in the form of a powder. During manufacture in each case one region of the applied powder layer is melted or sintered and then solidifies by cooling which corresponds to the layer of the finished component in the CAD model. After each layer a new powder layer is applied by means of a doctor blade and melted again positionally selectively with the next process step. After the process, the remaining powder can be removed from the component.

In the chemical or photochemical methods, the solidification of the three-dimensional component is achieved by a chemical reaction (chemical curing, polymerization, cross-linking). The individual layers of the component are in this case produced by positionally selective, photo-induced curing of the photosensitive construction material, e.g. a photo-resin. The most well-known photochemical methods are stereolithography (SLA) in which the positionally selective curing is accomplished by a laser beam and projecting methods using digital mirror or LCD arrangements which bring about a spatial light modulation. In both process techniques, construction hitherto takes place on a building platform in a monomer/pre-polymer bath in which projection or illumination takes place from the upper side or from the lower side. Both methods usually use electromagnetic radiation for curing the construction material. They differ in the type of selective irradiation.

In order to avoid additional support structures during construction of the components, a photochemical method for additive manufacture of components is known from WO 2016/008876 A1 in which a material is used as construction material which during the additive manufacture can undergo a further phase transition controllable by cooling between the liquid phase and a solid aggregate state as a second solid phase which does not influence the first photochemically produced solid phase. The further phase transition is controlled during the construction of the components so that whilst forming the first solid phase solidified component regions are supported by surrounding construction material in the second solid phase. WO 2012/140658 A2 discloses a similar method in which the construction material consists of a mixture of a photopolymer with a wax which makes possible the transition into the second solid phase during cooling. After each construction process of one or several adjacently arranged components, however, in both methods the building platform with the components constructed thereon must be removed and a new building platform inserted. This is a time-consuming process which so far prevents the use of such methods for a small batch or batch production.

DE 10 2012 021 284 A1 describes an apparatus and a method for the additive manufacture of components by means of photopolymerization in which a roller mounted rotatably in a container forms the substrate for the construction of the components. A plurality of exposure units for exposure of the liquid construction material are arranged around the roller. The container is formed with optically transparent sides at different distances from the lateral surface of the roller. The plurality of exposure units form a plurality of exposure stations along the circumferential direction of the roller. The apparatus enables a continuous fabrication of the components. However, in this method support structures are required for the construction of the components. Construction on a curved building surface and polymerization at an optically transparent container wall are additionally time-consuming and beset with problems.

Known from EP 2289462 A1 is a method for additive manufacture of components using a material powder. In this method successive layers are applied in layer planes which are aligned obliquely to the surface of the building platform. This also makes it possible to continuously manufacture the components.

It is the object of the present invention to provide a method and an assembly for additive manufacture of components which enables a continuous or quasi-continuous manufacture of the components and which is suitable for small-batch or batch production of components from a material with different geometries of the components.

### DESCRIPTION OF THE INVENTION

The object is achieved with the method and the assembly according to Patent claims 1 and 10. Advantageous embodiments of the invention as well as the assembly are subject matter of the dependent patent claims or can be deduced from the following description and the exemplary embodiments.

In the proposed method for additive manufacture of components, the components are constructed by layer-by-layer solidification of a construction material in a construction direction, which material can be transferred by a chemical or photochemical reaction from a liquid into a first solid phase. For this purpose the construction material has a material component determining the solidification which can be transferred accordingly by the chemical or photochemical reaction from the liquid into the first solid phase. The construction material can consist only of this material component or also contain further additives. The layer-by-layer solidification is accomplished in this case with the formation of the first solid phase in each case by positionally selective local irradiation of a layer of the liquid phase of the construction material according to the component geometry. As a result of this irradiation, the chemical or photochemical reaction, in particular a cross-linking or polymerization reaction is initiated in the irradiated region.

In the proposed method, the construction material, in particular the above material component of the construction material determining the solidification is selected such that during the additive manufacture the construction material or the material component determining the solidification can undergo a further phase transition controllable by cooling between the liquid phase or liquid aggregate state and a further solid aggregate state as a second solid phase which does not influence the first solid phase. The further phase transition is then controlled during the construction of the component, i.e., during the time interval from the start until the end of the manufacture of the respective component so that whilst forming the first solid phase, solidified component regions are supported by surrounding construction material which is present in the second solid phase. This way, during the additive manufacture the already solidified component regions are already embedded in solid construction material during or directly after solidification—or even after a time which can be set by selecting the external conditions—which solid construction material has been transferred into the second solid phase. The already-solidified component regions are supported by this solid construction material so that no supporting structures or additional supporting materials are required.

This solidification of the construction material by transition into the second solid phase enables a placement of components in the entire volume of the installation space without contact with a building platform. Thus, the installation space can be optimally utilized and consequently the number of components per printing process can be increased. Since the phase transition between the liquid and the second solid phase does not affect the first solid phase, the finished components can then be separated in a simple manner from the remaining construction material which for this purpose must only be transferred from the second phase into the liquid phase. The then liquid construction material can simply drop off or be completely separated from the components by supportive measures, for example, by heating and in the ideal case can be re-used. A complete freeing of the components from still-liquid material can be accomplished by a washing with appropriate solvents.

As a result of the solidification of the construction material by cooling, a block of solidified construction material is formed with the solidified component regions located therein. A block of solidified construction material is to be understood in the present patent application as a body having a thickness or height and constant cross-sectional area, wherein the thickness or height of the block is measured in the construction direction of the components and can vary during the additive manufacturing process. In the proposed method this block of solidified construction material is conveyed contrary to the construction direction by an advancing device which laterally approaches or engages the block in relation to the construction direction in order to construct the components in a layer-by-layer manner. This conveyance by elements of the advancing device which approach or engage the block of solidified construction material laterally enables an uninterrupted stepwise or continuous advancement by means of which new components can be continuously produced. A suitable substrate, for example, a plate made of a construction material solidified by transition into the second phase or made of another material is merely required for the start of the construction process. After the formation of a sufficiently thick or high block of solidified construction material, the components are then continuously produced by continuous advancement of the block. The components are in this case constructed one above the other in the construction direction, wherein naturally a plurality of components can lie next to one another in each case.

The term phase is used in the present patent application in the sense of a classical aggregate state (solid, liquid, gaseous) in order to distinguish liquid and solid states of the construction material. Thus, for example, a sol-gel transition is not a phase transition in the sense of the proposed method. The different states or phases can in this case not only be distinguished in the order state but also in the chemical compound.

The terms radiation or irradiation include in the present patent application both electromagnetic radiation such as, for example, UV or visual light or microwave radiation and also particle radiation such as, for example, electron radiation.

Preferably the block of solidified construction material with the components located therein is conveyed in this case from a temperature zone in which the construction material goes over into the second solid phase or remains in the second solid phase into a temperature zone in which the construction material is transferred from the second solid phase back into the liquid phase and thus the block is released and the components can be separated from the then liquid construction material.

The advancement of the block of solidified construction material by lateral approach or engagement of elements of the advancing device can be accomplished by means of different technologies. For this purpose, for example, bands, belts, grippers, wheels, gear wheels, a screw etc. can be used as elements of the advancing device. The construction and therefore also the conveying direction in the proposed method preferably run vertically or almost vertically. Fundamentally however other construction and conveying directions are also possible for carrying out the proposed method.

In the proposed method the construction material or the material component determining the solidification contained therein is selected so that the further phase transition can be produced by heating and/or cooling. In this case, this therefore involves a purely physical process of melting and solidification. Thus, depending on the ambient temperature during the additive manufacture and the melting or solidification point of the construction material, this phase transition is carried out either by an increase in temperature from the second solid phase into the liquid phase or by cooling from the liquid into the second solid phase. The respectively opposite transition can be accomplished automatically depending on the ambient temperature as soon as cooling is no longer carried out or heating is no longer carried out. Thus, for example, the construction material for each layer can be applied as liquid in already-heated form and then cools down automatically as a result of a lower ambient temperature with the formation of the second solid phase. The cooling can naturally also be accelerated by explicit cooling. Particularly advantageously a construction material is used which is liquid at room temperature (20° C.). The transition into the second solid phase is then achieved by cooling.

Preferably a photo-cross-linkable construction material is used, for example, a photoresin consisting of several components which, by increasing or lowering the temperature can implement a phase transition from solid to liquid and conversely. As a result, this construction material can be used controllably or adjustably either as a solid support material or as liquid construction material for the component.

Possible classes of material for the construction material or the material component determining the solidification are polymers, pre-polymers or monomers having one or more functional groups such as epoxides (glycidylether), acrylates, methacrylates, vinylether, allylether, thiols, norbornene, proteins and other in particular biological substances which under irradiation with UV light chemically cross-link or polymerize directly and/or in combination with a photo-initiator. In addition, the construction materials used can also contain such as, for example, metal powder, ceramic powder, fibres, particles, conducting substances or also absorbers, inhibitors, initiators, reactive diluents, softeners, solvents and other additives such as, for example, nanoparticles.

In an advantageous embodiment of the method, the construction material for each layer is initially applied in liquid form as a uniform layer, then irradiated positionally selectively in the liquid form and after the formation of the solidified component regions of the layer (first solid phase) is transferred into the second phase in the remaining regions. This transfer can be achieved by targeted active cooling of the respective layer or also as a result of the ambient or installation space temperature which must then lie below the solidification temperature of the liquid construction material.

In a further advantageous embodiment, the construction material likewise for each layer is also initially applied in liquid form as a cohesive layer and then transferred over the entire area, i.e. over the entire layer, into the second solid phase. The entire newly applied layer is then present in solid form in the second solid phase. This can in turn be accomplished by active cooling or also as a result of an installation space temperature which lies below the solidification point of the liquid phase.

The proposed assembly for the additive manufacture of components comprises a processing head which has an application device for the planar application of a construction material to a processing surface and a device for the projection or focussing of electromagnetic radiation or particle radiation onto the processing surface. The processing head is preferably mounted movably above the processing surface. The device for the projection or focussing of electromagnetic radiation or particle radiation (beam-guiding and/or focussing device) is configured so that it enables a positionally selective irradiation of the processing surface. The assembly further comprises an advancing device by means of which a block of solidified construction material formed by transition into a solid phase (second solid phase) can be conveyed contrary to a construction direction of the components and an outer guide for the block of solidified construction material along which the block of solidified construction material can be conveyed by the advancing device. The guide has an inlet opening in which region the processing surface lies and an outlet opening via which the block of solidified construction material and/or components fabricated using the assembly can emerge or be removed from the guide.

In an advantageous embodiment of this assembly, the advancing device is configured so that it conveys the block of solidified construction material by elements which laterally approach or engage the block in relation to the construction direction. Preferably the outlet opening lies opposite the inlet opening in this embodiment. This configuration enables the continuous or permanent stepwise conveyance of the block of solidified construction material by the advancing device.

In an alternative embodiment, the outlet opening of the guide is arranged laterally in relation to the construction direction. Via this lateral opening, the block of solidified construction material can then be removed, expelled or ejected. In this embodiment the assembly can then, for example, have an ejection mechanism by means of which the block of solidified construction material can be ejected via the lateral outlet opening. In this embodiment a conventional building platform can be used for the advancement of the block of solidified construction material. After fabricating some components, the production process is briefly interrupted and the block of solidified construction material with these components is conveyed to the outlet opening and ejected via the outlet opening. The building platform then returns immediately into a starting position for starting a construction process and a new construction process is begun. This embodiment does not enable a continuous but a quasi-continuous manufacture of the components, merely interrupted by the repeated ejection process.

In the proposed assembly the guide can, for example, be configured as a tube of arbitrary cross-sectional shape, i.e. for example, a round or also an angular cross-sectional shape. When using a laterally approaching or engaging advancing device, this guide tube then accordingly has lateral openings for access of the approaching or engaging elements of the advancing device. Instead of a corresponding tube, the guide can also be formed by tube sections running next to one another in the construction direction and spaced apart from one another or also by guide rails.

With the proposed method and the appurtenant assembly, it is possible to transfer the additive manufacture of polymer functional parts from an individual production process to small-batch or batch production. The method or the assembly can then continuously fabricate different geometries from one material from CAD without tools. The method and the assembly can be used for all areas of application in which three-dimensional objects should be produced by additive manufacture. Possible applications are small batches of polymer functional parts: pre-series, small machine parts, assembly aids, replacement parts, lost moulds (models for jewellery, hearing aids or models in dental medicine). The individual components can be manufactured, for example, with clock times on the minute scale.

### BRIEF DESCRIPTION OF THE DRAWINGS

The proposed method and the appurtenant assembly are explained in detail once again hereinafter with reference to exemplary embodiments in connection with the drawings:

FIG. 1 shows an example for carrying out the method by means of the cross-sectional diagram of a corresponding assembly;

FIG. 2 shows a cross-section perpendicular to the construction or conveying direction through the installation space with the surrounding guide of the assembly from FIG. 1;

FIG. 3 shows a plan view of the installation space with the surrounding guide of the assembly from FIG. 1;

FIG. 4 shows four examples for advancing devices for conveying the first material block in the installation space;

FIG. 5 shows a further example for an advancing device for conveying the solid material block in the installation space;

FIG. 6 shows a schematic diagram which illustrates the beginning of the process of the proposed method;

FIG. 7 shows an example for a modular structure of an assembly with a plurality of production modules according to the present invention;

FIG. 8 shows a schematic diagram of the proposed assembly with a device for re-using non-exposed construction material;

FIG. 9 shows an example for a process management for integration of a chip into the components;

FIG. 10 shows an illustration for the space-filling arrangement of new components in the installation space volume;

FIG. 11 shows a schematic diagram of the process management including the production planning in one embodiment of the proposed method;

FIG. 12 shows a schematic diagram of one embodiment of the proposed assembly for a quasi-continuous manufacture;

FIG. 13 shows a schematic diagram of a further embodiment of the proposed assembly for a quasi-continuous manufacture; and

FIG. 14 shows an example for the arrangement and construction of the metering and doctor blade unit in one embodiment of the proposed assembly.

### WAYS FOR IMPLEMENTING THE INVENTION

The proposed method uses a technique for additive manufacture of components as described in WO 2016/008876 A1. In this case, two phase transitions of a liquid photopolymer are used as construction material in order to avoid the additional construction of support structures by appropriate process management. On the one hand, the photochemical curing of the photopolymer under selective exposure to suitable radiation such as, for example, UV light is used to produce a three-dimensional component layer-by-layer. On the other hand, by cooling a second phase transition (liquid-solid) is used in the still-liquid region surrounding the component in order to support the components in the volume by the solidification of the surrounding construction material. This transition of the construction material into the second solid phase is designated hereinafter as freezing-in and the correspondingly solidified construction material is designated as frozen material or frozen matrix. As a result of this freezing-in of the surrounding construction material, the components produced by irradiation are thus stabilized without additional support structures. Furthermore, in this method components can be placed in the entire volume of the installation space—without contact with any building platform—and thus the number of components per printing process can be increased. This is possible since each frozen layer can take over the function of a new building platform for components.

An exemplary photo-resin formulation (here acrylate-based) whose melting point T_{M} lies between the temperatures T₁ and T₂ is a combination of poly(ethylene glycol)methyletheracrylate (M_{N}=480 g/mol; CAS 32171-39-4; T_{M}: 6-7° C.) as the solidification-determining material component, photoinitiator diphenyl(2,4,6-trimethyl-benzoyl)phosphine oxide (e.g. 1 mass %)and the absorber Orasol® Orange, which forms a solid phase at T₁(<6° C.) and a liquid phase at T₂ (e.g. room temperature).

In the proposed method, this process management is used to manufacture components continuously or at least quasi-continuously. In this case, the frozen block of construction material formed by the freezing-in is used as the basis for a continuous or quasi-continuous advancement. In the proposed method, this frozen block is conveyed uninterruptedly contrary to the construction direction by an advancing device which approaches the frozen block or engages therein laterally in relation to the advancing or construction direction so that new components can be produced continuously.

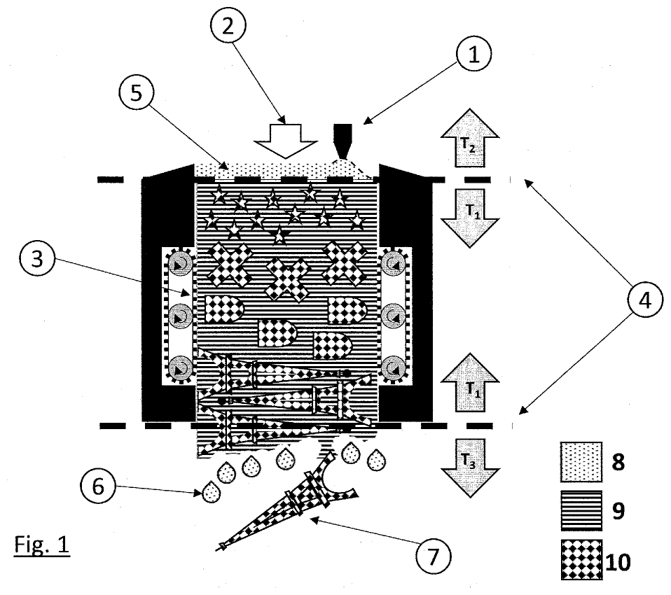

FIG. 1 shows a first example for the implementation of the proposed method in which the frozen block of construction material is moved continuously downwards by means of a suitable advancing device. Then ever new print jobs for the printing or construction of components can be begun from above whilst at the lower end of the frozen block the components are freed from the frozen matrix. FIG. 1 shows a section through a corresponding arrangement from which this procedure is apparent. In this example, this arrangement has a cylindrical outer guide 11 for the frozen block 9 which encloses the installation space volume.

In this example, the arrangement is divided into three temperature regions having the temperatures T₁, T₂ and T₃ which are selected depending on the construction material used. The temperature T₂ in the upper region is selected so that the layer 5 of construction material applied in this region using a unit 1 for metering and smoothing is present in the liquid state. By selective exposure in this region having the temperature T₂ with the aid of a suitable exposure unit 2, the photopolymer used to generate the components by means of radiation-induced polymerization or cross-linking can be transferred into the cured phase to construct the components 7 layer-by-layer. By advancement of the frozen block 9 of construction material located thereunder with the aid of the laterally approaching advancing device 3, this still-liquid layer 5 outside the component regions is then conveyed into the region having the temperature T₁ in which the surrounding construction material is transferred into the second solid phase, i.e. frozen in.

The diagram in FIG. 1 shows a situation during the continuous manufacturing process. As a result of the already-present block 9 of frozen construction material, an application of a new layer 5 of liquid construction material is possible in each case. It is possible to construct a (new) component on a frozen layer so that in the continuous process in principle no building platform is required. A solid substrate or plate is only required for the start of the process, i.e. for generating the first layers since a solid base must be provided for the layer application required in the process. As soon as a sufficiently stable body or block of thermally and photochemically cured material has been formed for the doctor blade application, the plate can be removed from the process. Each new frozen layer then serves as a base for a subsequent coating so that a continuous method of construction can be achieved. It is also possible to provide a frozen plate of construction material as a substrate at the beginning of the process and thus completely dispense with a substrate of a different material. Such a frozen plate can be produced in advance by suitable cooling of a thicker layer of the construction material. A plate made of a different material can, for example, also be introduced laterally only shortly before the beginning of the process and can be removed again after the production or formation of a sufficiently thick block of frozen construction material.

FIG. 1 also shows another temperature transition from the cooler temperature T₁ required for freezing-in the material to a higher temperature T₃ as a result of which the construction material is again transferred into the liquid state. The temperature T₃ can also correspond to the temperature T₂. The temperature transitions 4 are indicated in the figure by the dashed lines. The temperature gradient from warm (T2)-cold (T1)-warm (T3) in this case enables a liquid application of the construction material by the unit for metering and smoothing 1 in the first warm region (top), advancement of a solid volume element in the frozen state (frozen block 9) in the cold region (middle) and a renewed melting of the frozen volume element or block 9 in the second warm region of the process (bottom). As a result of the liquefaction of the frozen block 9 on transition into the temperature region having the temperature T₃, the construction material not required for the construction of the components is liquefied and can thus be separated from the components produced, as is indicated schematically in the lower part of FIG. 1. The production of components 7 having different geometries can also be seen from this figure, which components are embedded in the frozen block 9 with the best possible utilization of the installation space volume.

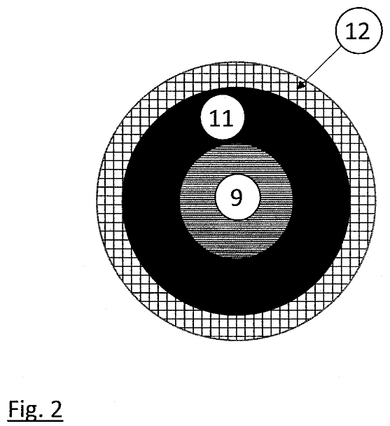

FIG. 2 shows a cross-section perpendicular to the construction direction through the installation space volume with the surrounding guide 11. In this case, a layer of the frozen block 9 can be identified inside the guide 11. This therefore comprises a section in the temperature region T1 of FIG. 1. In the present example, a cooling jacket 12 is used for cooling, which jacket is formed around the guide 11. The cooling can be accomplished using different techniques, preferably by electric cooling (Peltier elements) or by liquid cooling.

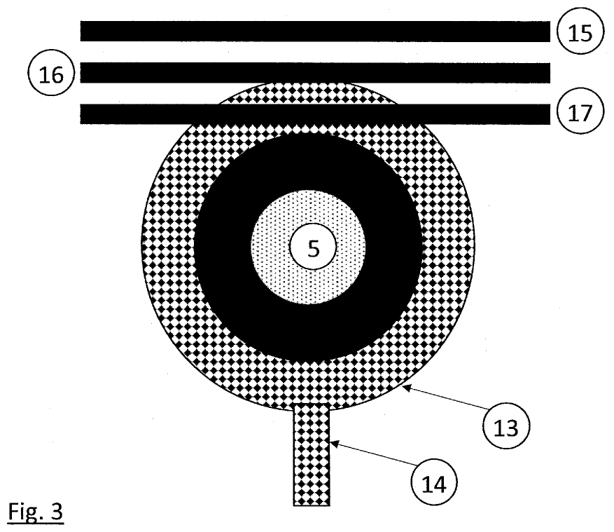

FIG. 3 shows a plan view of the arrangement from FIG. 1. In this plan view, the upper part of the guide 11 with the upper layer 3 applied therein can be identified. An overflow 13 for the liquid construction material and a drain 14 for this material can be identified around this upper part of the guide 11. The overflow 13 is required since the liquid material is applied in liquid form by the metering unit 17 and is then smoothed by the doctor blade unit 16. During this smoothing, excess material is pushed into the overflow 13 and can run off via the drain 14. Further units 15 for heating or cooling can also be arranged in this upper region.

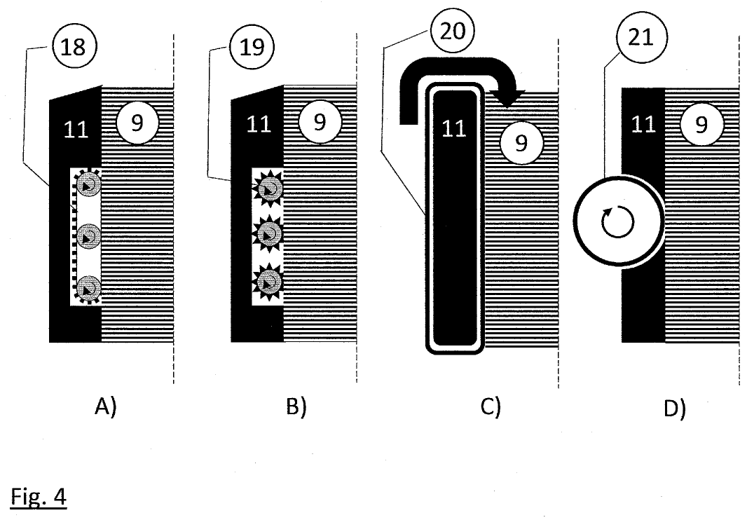

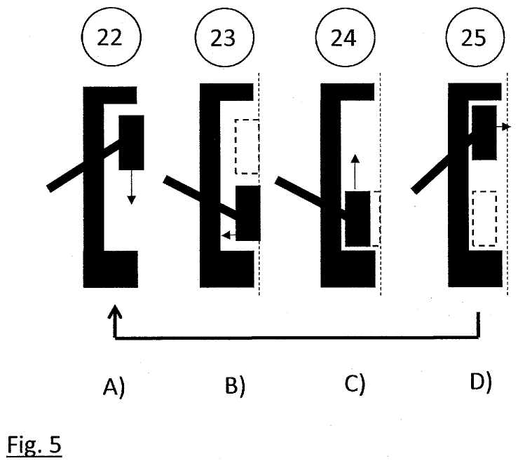

The advancement of the frozen block can be accomplished by means of various technologies. FIGS. 4 and 5 show examples for suitable advancement mechanisms. In FIG. 4 four exemplary techniques for this are shown in the subfigures A to D. The figure shows in each case a corresponding part of the guide 11 as well as the block 9 of frozen construction material conveyed in the guide by the advancing device. In Subfigure 4A the advancing device comprises a toothed belt 18, which acts on the frozen block 9 and moves this further during corresponding movement of the toothed belt 18. FIG. 4B shows an example of an advancing device in which the frozen block 9 is conveyed by means of gear wheels 19 which engage on the side of the frozen block 9. FIG. 4C shows an example in which the advancing device is formed by a jacket 20 running around the guide 11—or a part of the guide 11, which for example can be formed by a fabric or a rubber-like mat. FIG. 4C finally shows an advancement by suitable rotating elements, for example, a rotating roller 21, let into the guide 11.

Another possibility for advancement consists in the use of a suitable feeding unit as shown in FIG. 5 in four different phases. In this figure the guide 11 has a suitable recess inside which the feeding unit can perform the movement indicated in the four phases. In this example, in a first phase 22 a stamp pressed against the side of the frozen block is moved in the feeding direction (direction of the arrow) (FIG. 5A). In the next phase 23 the stamp is withdrawn from the frozen block (FIG. 5B) and in the subsequent phase 24 is moved into a starting position again (FIG. 5C). In phase 25 the movement of the stamp towards the material block then follows (FIG. 5D). By repeatedly passing through these phases, the frozen block can thus be moved further in the advancing direction. The stamp of the feeding device is moved in this case by means of a suitable linkage. A plurality of such feeding devices can also be arranged around the guide 11.

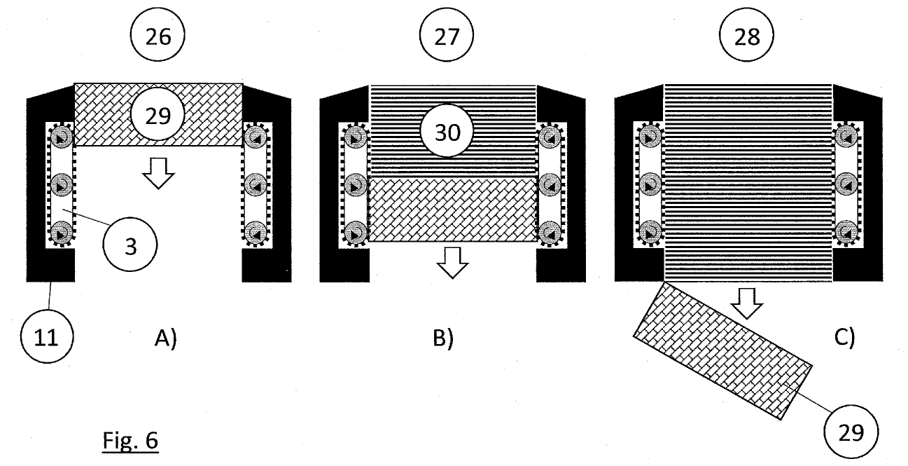

FIG. 6 shows an example for the starting of the printing or manufacturing process using the proposed method. In this example, initially a thick plate 29 is inserted in the guide 11 so that it can be conveyed via the advancing device 3 in the direction of the arrow (FIG. 6A). Construction of the components is then commenced wherein in each case the surrounding construction material not used for the construction of the components is frozen in in order to form a solid material block (FIG. 63) which corresponds to the frozen block 9 of the preceding figures. The finished components as well as the different temperature zones (cf. FIG. 1) are not shown here. As soon as the region with the plate 29 due to conveyance by means of the advancing device, enters into the region of higher temperature in which the frozen construction material is again transferred into the liquid state, the plate 29 is released and can be removed (FIG. 6C). It is then no longer required for the further continuous manufacture.

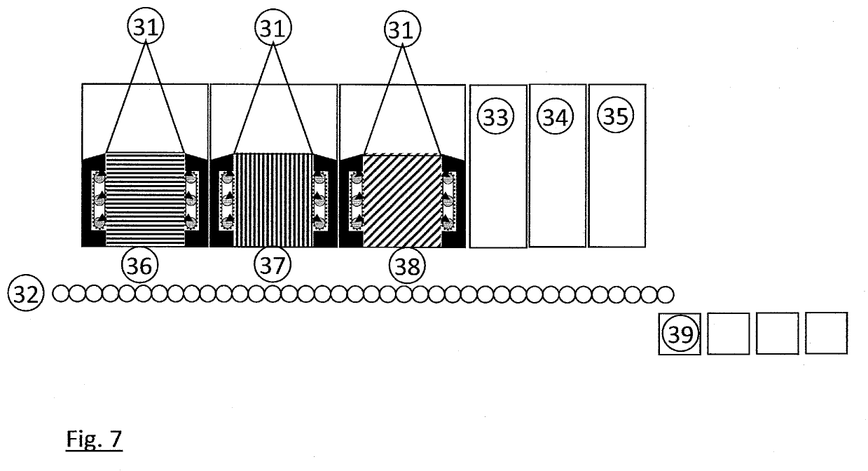

The proposed arrangement can also be used in modular fashion. To this end, FIG. 7 shows a modular construction in a process chain with several production modules 36 to 38 which are each formed according to the proposed arrangement. In the present example here three of these production modules are connected one after the other, each comprising exposure units 31 having the same or different geometrical construction. The production units 36 to 38 shown in the figure can in this case be operated with the same material or also with different material. Located underneath the production modules 36 to 38 is a conveying unit 32 for conveying the components which fall out after liquefaction of the frozen block (cf. FIG. 1). This conveying unit 32 is configured so that the liquid construction material can pass through the conveying unit into a collecting tank located thereunder (not shown). The conveying unit 32 thus forms a type of sieve for separating the liquid construction material. The components are in turn received by the conveying device 32 and transported along the conveying device 32 to post-processing units. In this example, these post-processing units comprise a washing unit 33, a unit 34 for after-curing of the components, for example, by means of UV radiation and/or temperature treatment and a unit 35 for quality control. The washing unit 33 is used to clean the components with a solvent and can, for example, be configured as a shower, bath or ultrasound bath. The quality control is preferably accomplished by scanning the components and separating out faulty products. This can be accomplished, for example, whereby a scanner measures the finished components three-dimensionally and compares them with a specification. If the geometry of the components agrees with the specification within predefined tolerances (set-actual comparison), the components are conveyed further. If a deviation occurs, the components are separated out. An acknowledgement is then given that the separated component must be re-printed. It is also possible to use a scanner for an electromagnetically readable chip which was integrated into the components in one embodiment in the method. This makes it possible to identify or assign the components which can then be sorted accordingly. Alternatively to the electromagnetically readable chip, barcodes, number codes or QR codes can also be attached to the components during manufacture in order to enable such an assignment. These are then read out accordingly by the scanner. In an adjoining sorting unit 39, the different product groups are then sorted according to their batch and faulty components are separated out.

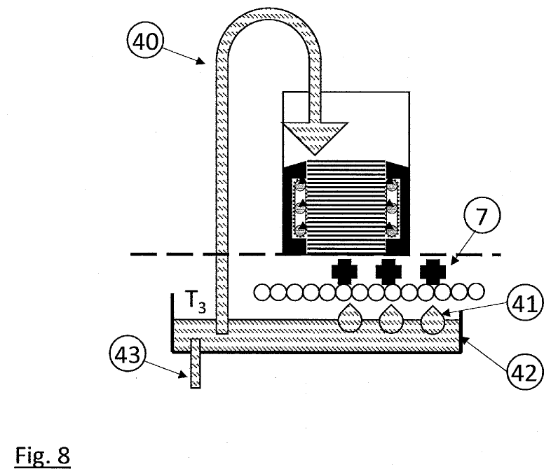

FIG. 8 shows an exemplary diagram of the proposed assembly in which the conveying unit 32 described in FIG. 7 with the collecting tank 42 located thereunder for construction material 41 which drips down due to melting in the temperature range T₃ (cf. FIG. 1) can be identified. In this diagram two possibilities for the re-use of the non-exposed construction material are indicated. On the one hand, the liquid construction material can be conveyed from the collecting tank 42 via a suitable line 40 back into a storage tank for the application of fresh construction material. Another possibility consists in manually draining the liquid construction material via a filling nozzle 43 and returning it for the construction of further components.

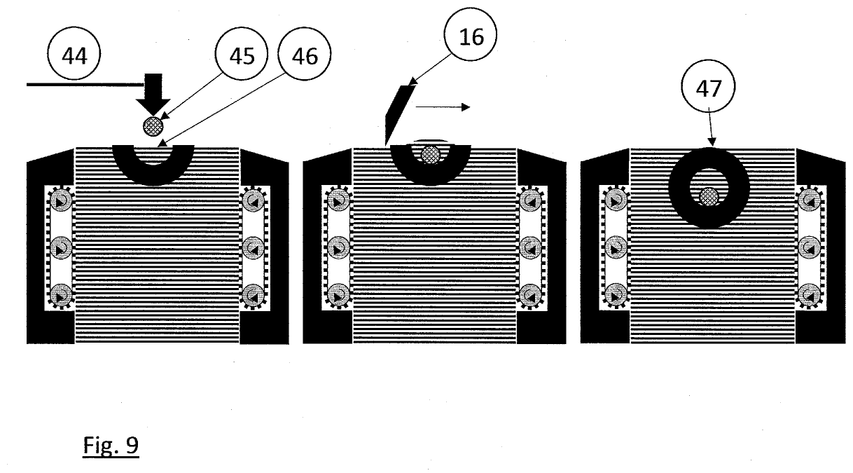

In principle, the finished components can be provided with a label/tag during manufacture so that they can be better sorted subsequently or, for example, assigned to a client or a product (cf. also FIG. 7). This can be accomplished, for example, by printing a bar code, a number code, a QR code or similar on the component. Alternatively, a type of flag can be inserted on the component during manufacture on which this unique code is printed to identify the component. This code and also, for example, the flag can be produced during manufacture as structures on the component by suitable solidification of the component material by exposure (first solid phase). Another possibility consists in integrating an electronically readable chip, an RF ID chip or similar into the component during manufacture. This procedure is indicated schematically in FIG. 9. The chip 45 is in this case placed in a hollow space or a cavity 46 in the component. The component 7 is in this case merely configured as spherical for illustration. Since frozen construction material is present in the cavity 46 as a result of the proposed method, the chip 45 must be heated previously in order to be able to insert it in the cavity 46 with the frozen construction material contained therein. A placement unit 44 for the heated chip 45 is provided for insertion. The chip is inserted into this cavity 46 of the component during manufacture, as can be seen in the central part of FIG. 9. Excess construction material is then removed with the aid of a doctor blade 16. After completion, a component 47 with integrated chip is thereby obtained. Instead of a chip, naturally other elements can also be integrated in the component in this manner.

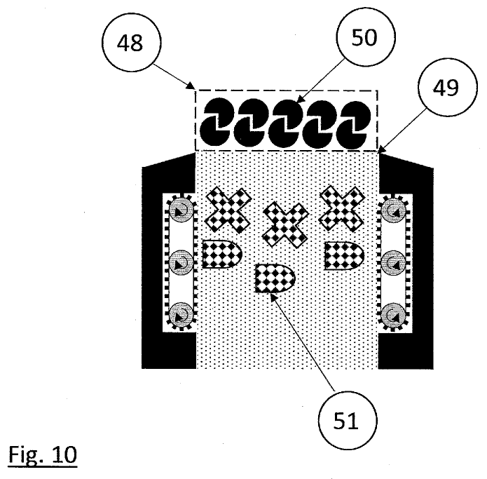

For the control of the manufacturing process, preferably a software is used by means of which the manufacture, in particular the arrangement of the components to be manufactured in the installation space volume and also the sequence of the manufacture are specified. The software is preferably configured so that during manufacture of the components in each case it receives components to be newly manufactured or the data thereof and introduces them suitably into the manufacturing process. In this case, the software should enable an automatic “after-shift” of components. This can be implemented by arranging the components digitally in a queue and then placing them in a free volume of the installation space depending on their size and their geometry. The software identifies in this case the currently fabricated and the respectively following layers of the planned components and arranges new components accordingly. This enables a space-filling arrangement of the components (tight packing) by means of which the throughput during manufacture can be increased. For this purpose, FIG. 10 shows an example of a space-filling arrangement of new components in the installation space volume for pending print jobs. The planned component layers or component volumes 48 for pending print jobs are indicated in the figure by the dashed line over the layer 49 last manufactured. In this example, the components 51 already printed are already present in the frozen block. The subsequently planned objects 50 are placed in space-filling arrangement in the planned component layers or the planned component volume 48.

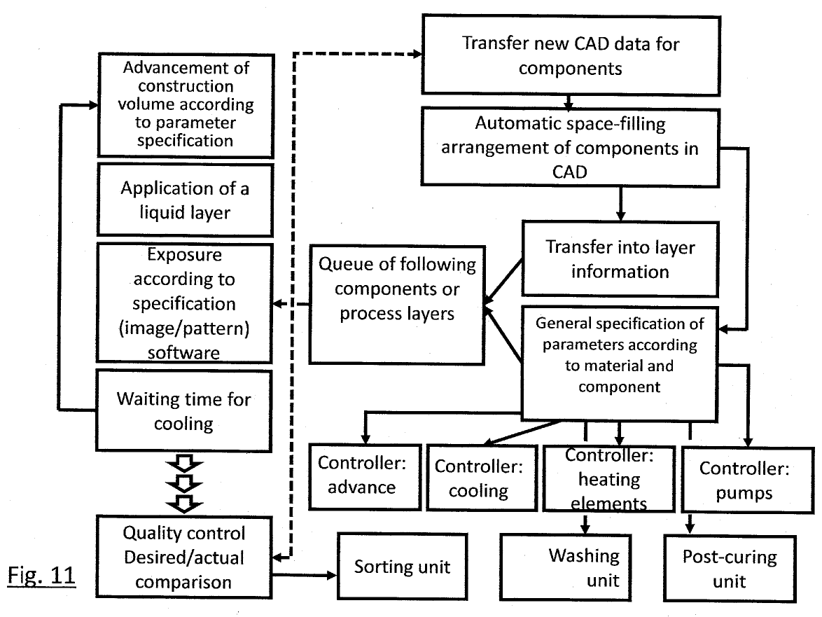

FIG. 11 shows a schematic diagram of the sequence of the proposed method including the pre-planning by the software described above for the arrangement of the components in the installation space volume. The individual components of the assembly for manufacturing the components are also controlled by the controller containing this software.

A process monitoring can also be used for the manufacture which, for example, determines the advancement or the current position of the respectively last applied layer of the construction material in relation to the construction direction or also the distance of this layer from a reference position. This can be accomplished by means of an optical distance measurement, a mechanical distance measurement or also by printing a suitable encoder, for example, a bar pattern on the side of the frozen block which is then read out accordingly by a scanning unit. In this way, the position of the individual components or also the layer thickness of the applied layers can be monitored at any time.

For the advancement of the frozen block it is also possible to print a suitable structure on the side of the frozen block which improves the control of the advancement. Thus, for example, a type of conveyor rail can be imprinted which improves the engagement of gear wheels for the advancement. Furthermore, correspondingly solidified regions can also be produced as anchors in the production process in each case concomitantly in the frozen block which comprise a part of the respective cross-sectional area or also the entire cross-sectional area. The production or printing of these structures is accomplished by corresponding exposure, i.e. the transition of the construction material into the first solid phase.

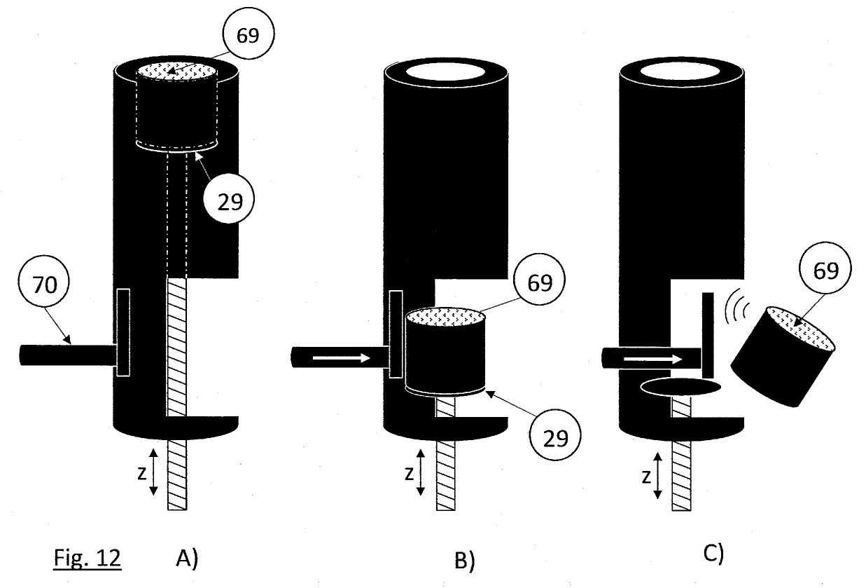

The previous exemplary embodiments showed a configuration of the arrangement for a continuous manufacture. However, the possibility of a quasi-continuous manufacture also exists in which after a defined process time in each case a block of frozen construction material fabricated by the method with the components located therein is ejected laterally from the guide and then liquefied again in order to separate the components from the construction material. A first example for such an assembly is shown in FIG. 12 which shows three phases of this process. In this example, the guide 11 on the lower part has a lateral opening through which a corresponding block of frozen construction material can be ejected after completion of the components. This assembly uses a building platform 29 for construction of the components. After completion of the desired number of components (FIG. 12A), the frozen block with the components is moved downwards through the building platform 29 (FIG. 12B) and ejected from the opening by a lateral ejector 70 (FIG. 12C). As a result, the construction process is interrupted and can only be continued after return of the building platform 29 to the upper region of the guide 11. As a result of the possibility of rapid ejection of the frozen block, however only very little time is required for this so that the construction process can already be continued shortly afterwards.

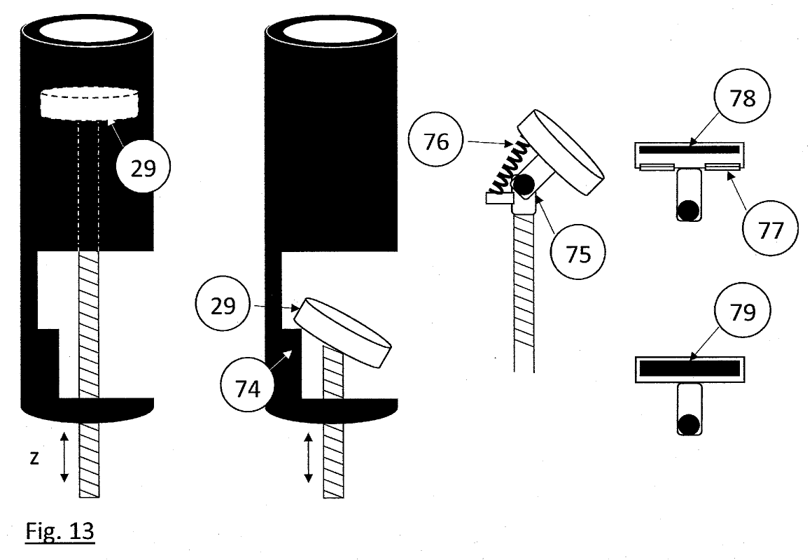

FIG. 13 shows a second example for an assembly for quasi-continuous manufacture in which the building platform 29 is designed to be tiltable and heatable. In contrast to the configuration of FIG. 12, in this example a lateral ejector is no longer required. After fabrication of the desired number of components, the frozen block with the components is moved downwards through the building platform 29. At the lower end of the guide 11, the building platform 29 hits against a mechanical stop 74 formed laterally there and tilts towards the lateral opening as a result of the built-in joint 75 there. As a result of simultaneous heating of the building platform by means of the integrated heating unit 78 (or combined heating/cooling unit 79), the block is released from the building platform 29 and is ejected via the opening. The right-hand part of the figure shows the joint 75 of the building platform 29 and a retaining spring 76 by means of which the building platform is brought back into a horizontal position upon return to the starting position, as well as a heating unit 78 and cooling unit 77 or combined heating/cooling unit 79 integrated in the building platform.

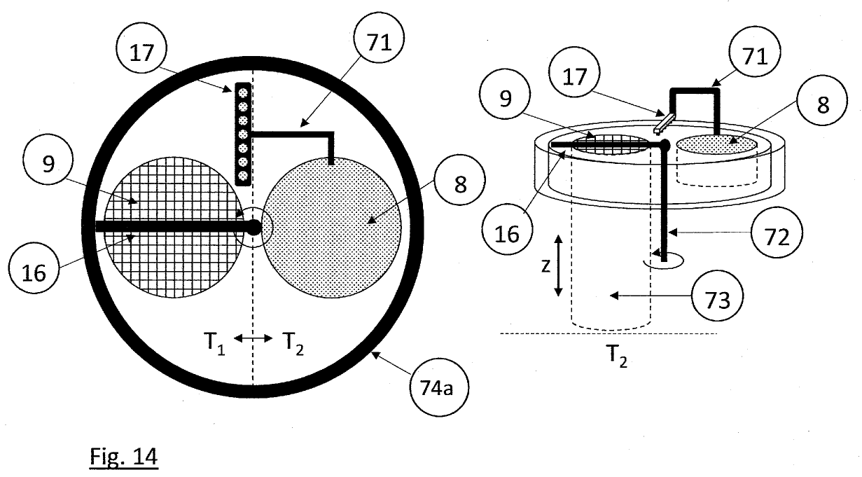

FIG. 14 finally shows an example for a configuration of the assembly in the upper region of the guide with the metering unit 17 and the doctor blade unit 16. The left-hand part of the figure shows in plan view the still liquid construction material 8 in a storage tank and the material 9 already frozen inside the guide in the installation space. In this diagram the doctor blade unit moves over the installation space 73 whilst the metering unit 17 is already in the waiting position for the application of a further layer. In this example, two temperature ranges are maintained for the temperature T1 (solidification of the construction material) and the temperature T2 (liquid construction material) in the upper region of the guide. The metering unit 17 is connected to a material supply line 71 which can optionally also be designed to be heatable. The movement of the doctor blade of the doctor blade unit 16 is accomplished by means of a rotary drive 72 as shown in the right-hand part of the figure in side view. The installation space 73 for the continuous manufacture is also indicated in this diagram. The collecting tank 74a for the liquid construction material removed by the doctor blade 16 can also be identified in the figure.

The proposed method and the proposed assemblies enable a continuous or quasi-continuous operating mode during printing of three-dimensional components. It is no longer necessary to change the building platform so that corresponding staff or additional equipment can be dispensed with. The method enables a high number of items from the CAD to the finished functional parts. As a result of the continuous manufacture, an automatic queue of components is also possible (printing “on the fly”) in which components to be newly manufactured can be received at any time. A modular design enables an easy upscaling and a production of polymer parts even in higher numbers of items.

### REFERENCE LIST

1 Unit for metering and smoothing
2 Exposure unit
3 Advancing device
4 Transition into the next temperature zone (gradient)
5 Liquid layer of construction material
6 Melting of regions not pertaining to the component
7 Components
8 Liquid material
9 Frozen material/frozen block
10 UV-hardened material (photopolymerized, photocross-linked)
11 Guide
12 Cooling jacket
13 Overflow
14 Drain
15 Units for heating and cooling
16 Doctor blade unit
17 Metering unit
18 Toothed belt
19 Gear wheels
20 Circumferential jacket
21 Rotating roller
22 Movement of a stamp in the feeding direction
23 Removal from the material block
24 Movement in the starting situation
25 Renewed feeding to material block
26 Inserting the plate
27 Lowering the plate and first filling with frozen layers
28 Plate drops down
29 Plate/building platform
30 Solid material block
31 Exposure units
32 Conveying device
33 Washing unit
34 Post-curing unit
35 Unit for quality control
36-38 Production modules
39 Sorting unit
40 Line with pump
41 Dripping construction material
42 Collecting tank
43 Filling nozzle
44 Placement unit
45 Chip
46 Cavity
47 Component with integrated chip
48 Planned component layers/component volumes
49 Last layer from previous runs
50 Planned components
51 Already-fabricated components
69 Frozen block
70 Ejection device
71 Material supply line
72 Drive for rotating doctor blade unit
73 Installation space for continuous conveyance
74a Collecting tank
74 Solid stop as ejection
75 Joint
76 Retaining spring
77 Cooling unit (e.g. Peltier)
78 Heating unit
79 Combined heating/cooling unit

1. Method for the additive manufacture of components in which the components are constructed by layer-by-layer solidification of a construction material in a construction direction which can be transferred from a liquid into a first solid phase by a chemical reaction, wherein
the layer-by-layer solidification takes place with the formation of the first solid phase in each case by positionally selective irradiation of a layer of the liquid phase of the construction material according to the component geometry,
a material is used as construction material which during the additive manufacture can undergo a further phase transition controllable by cooling between the liquid phase and a solid aggregate state as a second solid phase which does not influence the first solid phase and
the further phase transition is controlled such during the construction of the components that with the formation of the first solid phase solidified component regions are supported by surrounding construction material in the second solid phase, characterized in that a block of solidified construction material formed by the transition into the second solid phase is conveyed contrary to the construction direction by an advancing device which laterally approaches or engages the block in relation to the construction direction in order to construct the components in a layer-by-layer manner.

2. Method according to claim 1,
characterized in
that a plurality of the components are constructed one above the other in the construction direction.

3. Method according to claim 2,
characterized in
that the block of solidified construction material is conveyed by the advancing device in a stepwise or continuous manner during the construction of the components.

4. Method according to claim 1,
characterized in
that for the start of the construction process a plate of the construction material formed in advance by transition into the second solid phase or a plate of a different material is used, onto which the construction material is then applied in the liquid phase and then solidified.

5. Method according to claim 4,
characterized in
that the construction material is applied layer-by-layer in the liquid phase to the plate or already solidified regions of the construction material and is transferred into the second solid phase before or after the formation of the solidified component regions of the respective layer.

6. Method according to claim 1,
characterized in
that in each case before the formation of the solidified component regions in the respective layer the construction material is transferred into the second solid phase over the entire area and in order to form the solidified component regions is initially transferred back into the liquid phase only in a positionally selective manner according to the component geometry.

7. Method according to claim 1,
characterized in
that a construction material which is liquid at a temperature of 20° C. is used.

8. Method according to claim 1,
characterized in
that the block of solidified construction material is conveyed by the advancing device into a region having a temperature by means of which the construction material is transferred from the second solid phase into the liquid phase in order to separate the liquid construction material from the components.

9. Method according to claim 1,
characterized in
that electronic chips or other identifiers are integrated into one or more of the components during manufacture by means of which the components can be identified.

10. Assembly for the additive manufacture of components, comprising
a processing head which has an application device for a planar application of a liquid construction material to a processing surface,
a device for the projection or focussing of electromagnetic radiation or particle radiation onto the processing surface which enables a positionally selective irradiation of the processing surface,
an advancing device by means of which a block of solidified construction material formed by transition into a solid phase can be conveyed contrary to a construction direction of the components and
an outer guide for the block of solidified construction material along which the block of solidified construction material can be conveyed by the advancing device,
wherein the guide has an inlet opening in which region the processing surface is situated and an outlet opening via which the block of solidified construction material and/or components fabricated using the assembly can emerge or be removed from the guide.

11. Assembly according to claim 10,
characterized in
that the advancing device is configured so that it conveys the block of solidified construction material by elements which laterally approach or engage the block in relation to the construction direction.

12. Assembly according to claim 11,
characterized in
that the outlet opening lies opposite the inlet opening.

13. Assembly according to claim 10,
characterized in
that the outlet opening is arranged laterally in relation to the construction direction and the assembly has an ejection mechanism by means of which the block of solidified construction material can be ejected via the lateral outlet opening.

14. Assembly according to claim 10,
characterized in
that it comprises a cooling device by means of which the liquid construction material applied to the processing surface can be cooled and thereby transferred into the solid phase in order to form the block of solidified construction material.

15. Assembly according to claim 10,
characterized in
that it comprises a heating device which is configured for a positionally selective or a planar heating of the construction material applied to the processing surface.

16. Assembly according to claim 10,
characterized in
that the device for the projection or focussing is attached to the processing head or integrated in the processing head.

17. Assembly according to claim 10,
characterized in
that the processing head is configured as a surface coater.

18. Assembly according to claim 10,
characterized in
that the guide is formed by a guide tube having an arbitrary cross-section in which the block of solidified construction material can be conveyed by the advancing device.

19. Assembly according to claim 10,
characterized in
that the assembly comprises at least a spatial region at a first temperature and a spatial region at a second temperature wherein the first temperature can be set to a value below and the second temperature can be set to a value above a solidification temperature of the construction material and the block of solidified construction material can be conveyed by the advancing device, optionally in combination with a transport device, from the spatial region at the first temperature into the spatial region at the second temperature.

20. Assembly according to claim 10,
characterized in
that the assembly comprises stations for washing, post-hardening and/or optical scanning of components produced using the assembly.

21. Assembly according to claim 10,
characterized in
that it comprises a control unit which arranges components to be manufactured in a space-saving manner in a construction volume and controls the assembly accordingly for the manufacturing of the components.
